(19) United States
(12) Patent Application Publication
(10) Pub. No.: US 2014/0015978 A1
(43) Pub. Date: Jan. 16, 2014

(54) BARRIERLESS GATE

(71) Applicant: CUBIC CORPORATION, San Diego, CA (US)

(72) Inventor: Gavin Smith, Crawley (GB)

(21) Appl. No.: 13/941,050

(22) Filed: Jul. 12, 2013

Related U.S. Application Data
(60) Provisional application No. 61/672,190, filed on Jul. 16, 2012.

(51) Int. Cl. G07C 9/00

(52) U.S. Cl. CPC G07C 9/00079
USPC 348/156

(57) ABSTRACT

A fast-track gateway that has one or more smart card validators positioned in a walkway leading to the gateway to permit smart card travelers swift entry and exit from transit platforms. The validators may be clearly marked and highly visible so that entry and exit taps or swipes may be easily performed by individuals who have adopted smart card payment media.

This application claims the benefit of U.S. Provisional Patent Application No. 61/672,190 filed 16 Jul. 2012 and entitled BARRIERLESS GATE, the entirety of which is incorporated by reference for all intents and purposes.

### BACKGROUND

Transportation stations often have barrier equipment in which passengers are able to gain entry upon confirmed or approved validation. That same equipment however may, for example, serve as a congestion point during relatively high passenger volume periods.

### SUMMARY

The Summary does not in any way limit the scope of the claimed subject matter.

In an aspect, a system may include a barrierless gate that defines a passageway, and the barrierless gate may separate a non-restricted access area from a restricted access area. In general, the gate is barrierless because the passageway is open and unimpeded so that an individual may freely walk or travel through the gate without encountering a blocking object or barrier. In general, the non-restricted access area is non-restricted because any individual may freely access or enter that area, without having to provide or supply some type of credential or be authorized to access that area. Conversely, the restricted access area is restricted because any individual may not freely access or enter that area, and may be required to provide or supply some type of credential or be authorized to access that area. The system may include at least one credential validator positioned at a particular distance from or as measured with respect to the barrierless gate within the non-restricted access area along a walkway leading to the barrierless gate and the passageway defined by the barrierless gate. In general, the at least one credential validator may be configured to detect some type of credential or item that identifies a particular individual, and determine whether or not an individual is authorized to access the restricted access area from the non-restricted access area. The system may include at least one image capture device that is coupled to the barrierless gate and that is configured to acquire at least one image of each individual that approaches the at least one credential validator along the walkway to enter the restricted access area though the passageway defined by the barrierless gate. In general, the at least one image capture device may be communicatively coupled to the at least one credential validator positioned and coupled to any portion of the barrierless gate as desired, and in any manner as desired, and may include any type of camera or imaging system configured to capture at least a portion of a face of each individual that approaches the barrierless gate for or with the purpose of entering the restricted access area from the non-restricted access area. The at least one image capture device may associate, based on information received from the at least one credential validator, at least one particular image with each individual determined unauthorized to enter the restricted access area. The at least one particular image may include at least a portion of a face of an associated individual so that each unauthorized individual may be identifiable by a fare enforcement entity. Other embodiments are possible.

Additionally, or alternatively, the at least one image capture device may be configured to acquire and associate a particular video sequence with each unauthorized individual based on information received from the at least one credential validator. In general, the particular video sequence may include or capture at least a portion of a face of an associated individual so that each unauthorized individual may be identifiable by a fare enforcement entity. Other embodiments are possible.

Additionally, or alternatively, the at least one image capture device may be configured to acquire and associate a particular image or video sequence with each individual that approaches the at least one credential validator along the walkway to enter the restricted access area though the barrierless gate based on absence of information received from the at least one credential validator about any particular individual. In general, an individual may intentionally or unintentionally bypass the at least one credential validator without being approved, validated, or authorized to enter the restricted access area from the non-restricted access area via the barrierless gate. In this and other scenarios the at least one image capture device may capture a particular image or video sequence that may include or capture at least a portion of a face of such an unauthorized individual so that the unauthorized individual may be identifiable by a fare enforcement entity. Other embodiments are possible.

Additionally, or alternatively, the at least one image capture device is further configured to at least one of: track each individual that approaches the at least one credential validator along the walkway to enter the restricted access area though the barrierless gate; link particular validation data, selected from one of data indicating confirmed validation or unconfirmed validation, received from the at least one credential validator with each tracked individual; or associate a particular image or video segment with each tracked individual having unconfirmed validation to enable the fare enforcement entity to identify individuals having unconfirmed validation. In general, the at least one image capture device may be configured to detect individuals approaching the walkway and follow and detect activity of those individuals as they proceed along the walkway to enter the restricted access area though the barrierless gate. The at least one image capture device may be configured to make a determination as to whether each particular individual is authorized or not to enter the restricted access area from the non-restricted access area, and mark or tag those individuals unauthorized to enter the restricted access area from the non-restricted access area. Since individuals determined authorized to enter the restricted access area from the non-restricted access area are determined as abiding to any terms required to enter the restricted access area, the at least one image capture device may be configured to not mark or tag those individuals authorized to enter the restricted access area from the non-restricted access area. Other embodiments are possible.

Additionally, or alternatively, the at least one image capture device may comprise an integrated camera and computing system communicatively coupled to the at least one credential validator, and may be configured to capture at least one image of each individual at a predefined distance from the barrierless gate within the non-restricted access area, and a video sequence of predetermined length of each individual within non-restricted access area that approaches the at least one credential validator along the walkway to enter the restricted access area though the barrierless gate. In general, the at least one image capture device may be both a camera and computing system or device configured to implement or perform multiple different operations or tasks in accordance with the present disclosure. The at least one image capture device may be communicatively coupled to any number and type of different computing systems or devices at least for the purpose of detecting and facilitating measures to mitigate potential fare evasion. Other embodiments are possible.

Additionally, or alternatively, the system may include a computing system communicatively coupled to the at least one image capture device and separate from the at least one credential validator and the at least one image capture device, where the at least one image capture device may be configured to generate and send to the computing system an event record for each individual unauthorized to enter the restricted access area, and where each particular event record may include at least one image of an associated individual. In general, the computing system may include one or more server computing devices configured to implement business processes and that may have access to localized and/or delocalized non-transitory memory so that potential fare evasion events may be securely created and stored for further action. Other embodiments are possible.

Additionally, or alternatively, the system may include at least one mobile computing device communicatively coupled to one of the at least one image capture device or a computing system separate from the at least one image capture device, where the at least one mobile computing device may be configured to receive from one of the at least one image capture device or the computing system a particular image or video sequence of each individual unauthorized to enter the restricted access area to enable the fare enforcement entity to identify individuals unauthorized to enter the restricted access area. In general, the mobile computing device may be configured as any type of handheld computing system or device as desired such as, for example, a smartphone, a tablet, a personal data assistant, or any other type of handheld, and further may exhibit one or more features typically found in or exhibited by such computing devices including, for example, one or more communication devices or modules, one or more processing devices or modules, one or more input and/or output devices or modules, and etc. Other embodiments are possible.

Additionally, or alternatively, the system may include a first partition and a second partition each extending from the barrierless gate within the non-restricted access area to define the walkway leading to the barrierless gate so that a corridor that leads from the non-restricted access area to the restricted access area is defined by the first and second partition and the barrierless gate, and where the at least one credential validator is coupled to one of the first partition or the second partition. In general, the first and second partition may each include some type of barrier so that individuals are guided or encouraged towards the at least one credential validator and the barrierless gate to enter the restricted access area from the non-restricted access area via the via the walkway and the passageway. Although the system may include two partitions, it is contemplated that more or fewer partitions or barrier-like objects or elements may be used in accordance with the present disclosure. Other embodiments are possible.

Additionally, or alternatively, the barrierless gate may comprise an arched structure so that to enter the restricted access area from the non-restricted access area each individual passes through the arched structure unimpeded by a barrier. In general, an arched structure may include or exhibit a curved or horseshoe-like shape that has at least first and second ends. Although, it is contemplated that the barrierless gate may include or exhibit any type of structural shape, feature, or features, as desired and in accordance with the present disclosure. In this manner, the barrierless gate serves as some type structure that is point of entry and delineates the non-restricted access area from the restricted access area. Other embodiments are possible.

Additionally, or alternatively, the at least one credential validator may comprise of at least one of a contact or contactless card reader configured to detect smart cards to validate fare collection and authorize access to the restricted access area. Although, it is contemplated that in accordance with the present disclosure the at least one credential validator may be configured and/or arranged as any type of validation or authorization mechanism as desired, and further such a mechanism may evolve as validation and/or authorization systems evolve. Other embodiments are possible.

In an aspect, a computer-implemented method may include tracking a particular individual that approaches a barrierless gate that separates a non-restricted access area from a restricted access area. In general, the gate is barrierless because a passage of the gate may be open and unimpeded so that an individual may freely walk or travel through the gate without encountering a blocking object or barrier. The computer-implemented method may include determining, based on information received from a smart card reader positioned at a particular distance from the barrierless gate within the non-restricted access area, whether the particular individual is authorized to access the restricted access area. Although the reader in this example is a smart card reader, it is contemplated the reader may be any type of credential or item validator that may be configured and/or arranged as any type of validation or authorization mechanism as desired, and further such a mechanism may evolve as validation and/or authorization systems evolve. The computer-implemented method may include capturing, when the particular individual is determined unauthorized to access the restricted access area, at least one of an image or video sequence of the particular individual to enable a fare enforcement entity to identify and confront the particular individual about potential unauthorized access to the restricted access area. In general, the least one of an image or video sequence of the particular individual may be captured by at least one image capture device that may be configured to make a determination as to whether the particular individual is authorized or not to enter the restricted access area from the non-restricted access area, and mark or tag the individual when unauthorized to enter the restricted access area from the non-restricted access area. In examples where the individual is determined authorized to enter the restricted access area from the non-restricted access area, the at least one image capture device may be configured to not mark or tag the individual. Other embodiments are possible.

Additionally, or alternatively, the computer-implemented method may include filtering the image or video sequence to remove information unrelated to the particular individual. It is contemplated that any type or form or combination of data or signal processing technique(s) may be performed in accordance with the present disclosure as desired to filter or otherwise modify the image or video sequence to remove or at least obscure, redact, etc., information unrelated to the particular individual, and further such an operation or operations may evolve as data or signal processing techniques evolve. Other embodiments are possible.

Additionally, or alternatively, the computer-implemented method may include performing a facial recognition algorithm against the image or video sequence to generate at least one classifier that characterizes at least one facial feature of the particular individual. It is contemplated that any type or form or combination of facial recognition technique(s) may be performed in accordance with the present disclosure as desired to generate at least one classifier that characterizes at least one facial feature of the particular individual, and further such an operation or operations may evolve as facial recognition techniques evolve. Other embodiments are possible.

Additionally, or alternatively, the computer-implemented method may include performing a data compression algorithm against the image or video sequence to encode the image or video sequence prior to transfer of the image or video sequence to secure data storage. It is contemplated that any type or form or combination of data compression technique(s) may be performed in accordance with the present disclosure as desired to encode the image or video sequence prior to transfer of the image or video sequence to secure data storage, and further such an operation or operations may evolve as data compression techniques evolve. Other embodiments are possible.

Additionally, or alternatively, the computer-implemented method may include at least one of: appending classifier data that characterizes at least one facial feature of the particular individual to the image or video sequence; encrypting the classifier data and the image or video sequence to form an event package; or transmitting the event package to a non-transitory storage medium for storage therein. In general, the event package may include one or more files that may include information about a potential fare evasion event. Other embodiments are possible.

Additionally, or alternatively, the computer-implemented method may include sending the image or video sequence to at least one mobile device for display thereon to enable a fare enforcement entity to identify and confront the particular individual about potential unauthorized access to the restricted access area. In general, the fare enforcement entity may access the image or video sequence using the mobile device to assist the fare enforcement entity in investigating and taking measure to address a potential fare evasion event. Other embodiments are possible.

Additionally, or alternatively, the computer-implemented method may include at least one of: appending classifier data that specifies at least one of date, time, location, or event type to the image or video sequence to form an event package; or transmitting the event package to a non-transitory storage medium for storage therein. In general, the event package may include one or more files that may include information about a potential fare evasion event. Other embodiments are possible.

Additionally, or alternatively, the computer-implemented method may include at least one of: determining, based on absence of information received from the smart card reader, that the particular individual is unauthorized to access the restricted access area; or in response to determining that the particular individual is unauthorized to access the restricted access area, capturing at least one of an image or video sequence of the particular individual, and sending the at least one of an image or video sequence to at least one mobile device to enable the fare enforcement entity to identify and confront the particular individual about potential unauthorized access to the restricted access area. In general, an individual may intentionally or unintentionally bypass the reader without being approved, validated, or authorized to enter the restricted access area from the non-restricted access area via the barrierless gate. In this and other scenarios a camera computing device or system may capture a particular image or video sequence that may include or capture at least a portion of a face of such an unauthorized individual so that the unauthorized individual may be identifiable by a fare enforcement entity. Other embodiments are possible.

In an aspect, an integrated camera and computing system positioned to a barrierless gate that defines a passageway and that separates a non-restricted access area from a restricted access area may include at least one of one or more processors or a memory communicatively coupled with and readable by the one or more processors and having stored therein processor-readable instructions which, when executed by one or more processors, cause the one or more processors to at least one of: track a particular individual that approaches the barrierless gate that separates the non-restricted access area from the restricted access area; determine, based on information received from a smart card validator positioned at a particular distance from the barrierless gate within the non-restricted access area, whether the particular individual is authorized to access the restricted access area; or when the particular individual is determined unauthorized to access the restricted access area, capture at least one of an image or video sequence of the particular individual to enable a fare enforcement entity to identify and confront the particular individual about potential unauthorized access to the restricted access area.

Additionally, or alternatively, the memory may have stored therein processor-readable instructions which, when executed by the one or more processors, cause the one or more processors to at least one of: filter the image or video sequence to remove information unrelated to the particular individual; perform a facial recognition algorithm against the image or video sequence to generate at least one classifier that characterizes at least one facial feature of the particular individual; perform a data compression algorithm against the image or video sequence to encode the image or video sequence prior to transfer of the image or video sequence to secure data storage; append classifier data that characterizes at least one facial feature of the particular individual to the image or video sequence; encrypting the classifier data and the image or video sequence to form an event package; and transmitting the event package to a non-transitory storage medium for storage therein; send the image or video sequence to at least one mobile device for display thereon to enable a fare enforcement entity to identify and confront the particular individual about potential unauthorized access to the restricted access area; or determine, based on absence of information received from the smart card reader, that the particular individual is unauthorized to access the restricted access area, capture at least one of an image or video sequence of the particular individual, and send the at least one of an image or video sequence to at least one mobile device to enable the fare enforcement entity to identify and confront the particular individual about potential unauthorized access to the restricted access area.

These and other aspects of the present disclosure may be beneficial and/or advantageous in many respects. For example, such aspects may allow passengers to flow freely through crowded stations. In another example, staff that may normally or typically be required to stand next to a gateline waiting for ticketless passengers could or may be mobilized to perform other functions on or at the station, and may only be summoned back to a gateline and/or barrierless gate area by a mobile device when needed. An appreciation of the various aspects of the present disclosure along with further associated benefits and/or advantages may be gained from the following discussion in connection with the drawings.

### DESCRIPTION OF THE DRAWINGS

FIG. 1 shows an example gate array in accordance with the present disclosure.

FIG. 2 shows a top view of a portion of the gate array of FIG. 1.

FIG. 3 shows an example networked computing environment in which aspects of the present disclosure may be implemented.

FIG. 4 shows a first example method in accordance with the present disclosure.

FIG. 5 shows a second example method in accordance with the present disclosure.

FIG. 6 shows a third example method in accordance with the present disclosure.

FIG. 7 shows a fourth example method in accordance with the present disclosure.

FIG. 8 shows an example computing system or device.

### DETAILED DESCRIPTION

The present disclosure is directed to or towards a fast-track gateway that has one or more smart card validators positioned in a walkway leading to the gateway to permit smart card travelers swift entry and exit from transit platforms. The validators may be clearly marked and highly visible so that entry and exit taps or swipes may be easily performed by individuals who have adopted smart card payment media. It is contemplated that travelers who have not yet adopted smart card payment media will be intrigued by the ease of entry and exit and so will be encouraged or motivated to adopt smart ticket media. It is further contemplated that the fast-track gateway may be incorporated within an existing gate array, gateline, etc., or may be used as a stand-alone validation and revenue protection system. Among other benefits or advantages, the fast-track gateway may allow for increased traveler throughput in busy stations and non-obtrusive revenue protection in remote stations. Although not so limited, an appreciation of the various aspects of the present disclosure may be gained from the following discussion in connection with the drawings.

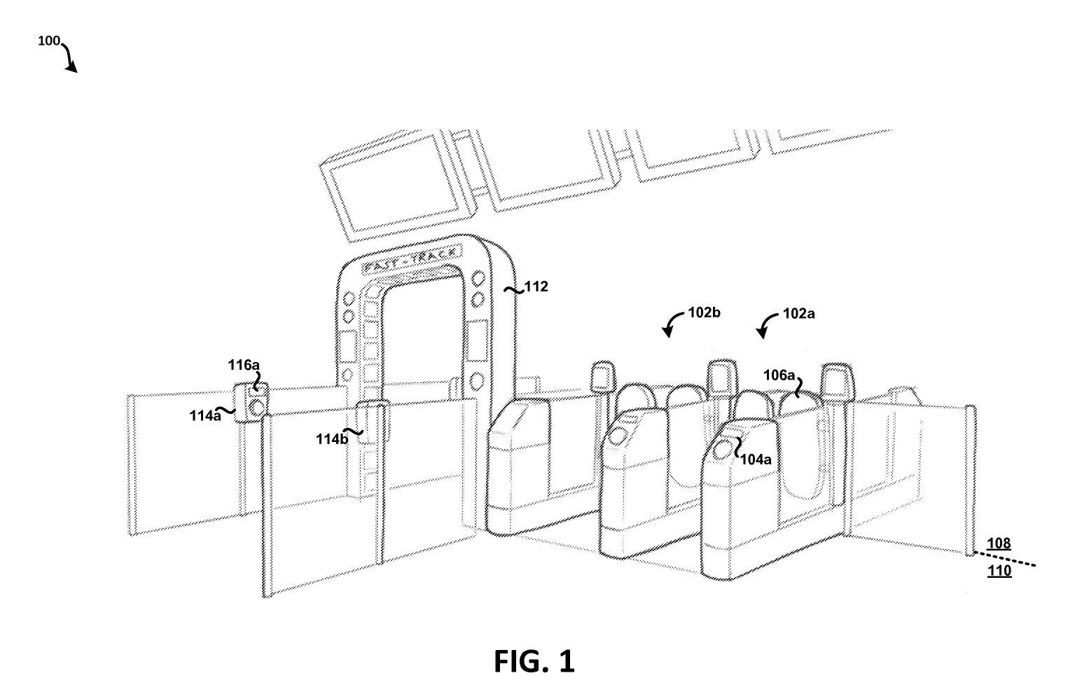

For instance, referring now to FIG. 1, an example gate array 100 is shown in accordance with the principles of the present disclosure. In general, the gate array 100 is similar to a typical gateline used in transportation scenarios or environments. For example, the gate array 100 may include a plurality of gated barrier equipment 102a-b. In practice, an individual may swipe a ticket or card across a reader 104a, for example, so that the individual may pass through a gate 106a of the gated barrier equipment 102a and gain access to a restricted access area 108 from a non-restricted access area 110. Such an implementation may generally be effective to prevent or at least hinder fare evasion. For example, when a particular ticket or card does not have sufficient funds or is invalid, the gate 106a may remain closed so as to prevent the individual from entering or accessing the restricted access area 108. It will be appreciated however that the gated barrier equipment 102a-b may, for example, at least serve as a congestion point during relatively high passenger volume periods.

To address this and other issues associated with the gated barrier equipment 102a-b, the gate array 100 may further include at least one barrierless gate or gateway 112. In general, the barrierless gate 112 defines an unimpeded or open passageway that separates the non-restricted access area 110 from the restricted access area 108. In practice, an individual may swipe or tap a smart card to or against a particular smart card validator 114a for example, of multiple smart card validators 114a-b, as the individual approaches the barrierless gate 112 to access the restricted access area 108 from the non-restricted access area 110. In this example, the smart card validator 114a may read the smart card, calculate the required fare, deduct the required fare from the smart card, and re-encode the smart card with a new stored value. The transaction may then be forwarded to a centralized computer system (not shown) for retention and/or further processing, and the individual may be immediately notified of fare status via one or both of audio and visual notification provided by the smart card validators 114a-b. For example, a display 116a of the smart card validator 114a may indicate that a particular smart card hold a remaining value of twenty pounds sterling.

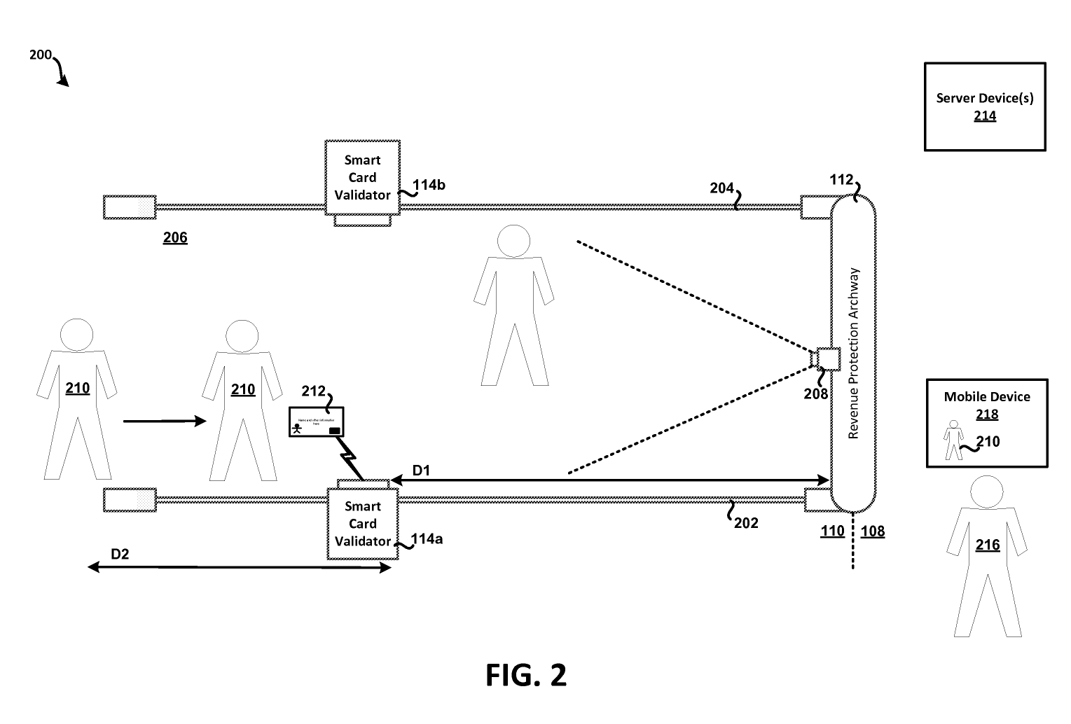

Upon validation the individual may pass freely, without encountering any obstacle or barrier, through the barrierless gate 112 to access the restricted access area 108 from the non-restricted access area 110. To prevent or mitigate potential fare evasion, such as when an individual passes through the barrierless gate 112 without validation, the barrierless gate 112 may utilize or incorporate video analytics in combination with the functionality offered or implemented by the smart card validators 114a-b. For example, referring now to FIG. 2, a top view 200 of a portion of the gate array 100 of FIG. 1 is shown in accordance with the principles of the present disclosure.

More specifically, FIG. 2 shows a first partition 202 and a second partition 204 each extending from the barrierless gate 112 within the non-restricted access area 110 to define a walkway 206. In this example, the smart card validator 114a is mounted to the first partition 202 at a particular distance D1 from the barrierless gate 112, and the smart card validator 114b is mounted to the second partition 204 at the particular distance D1 from the barrierless gate 112. Further, at least one camera device or system 208 is coupled to the barrierless gate 112. In general, the camera device 208 is an integrated image and video capture device and computing system that is communicatively coupled to each of the smart card validators 114a-b. The camera device 208 may be configured and arranged so as to have a field-of-view that at least covers the walkway 206 in its entirety. Further, the camera device 208 may be configured and arranged so as to be able to dynamically track and focus-on any object or person within the walkway 206 in its entirety.

In practice, and as discussed throughout, the camera device 208 may initially capture an image of a traveler 210 as the traveler 210 approaches the walkway 206, before the traveler 210 reaches any of the smart card validators 114a at about, for example, a particular distance D1+D2 as measured from the barrierless gate 112. The camera device 208 may then generally start tracking the traveler 210 as the traveler 210 further approaches the barrierless gate 112. As the traveler 210 touches a smart card 212 to the smart card validator 114a, for example, the smart card validator 114a may send a validation result to the camera device 208. The camera device 208 may exhibit or include video analytics software or firmware, and may compare a validation timestamp contained within the validation result with a tracked image of the traveler 210, and link the validation data to the traveler 210. When the validation is “good,” the traveler 210 may be marked or tagged “of no interest.” At this point, the camera device 208 may cease tracking the individual. When the validation is “bad,” however, the traveler 210 may be continued to be tracked and marked or tagged “invalid ticket.” When the traveler 210 is marked neither “of no interest” nor “invalid ticket” by the time the traveler 210 passes through the barrierless gate 112, and out of view of the camera device 208, the traveler 210 may be marked as “fraudulent.” In the example implementation, when the traveler 210 presents a “fake” ticket that does nothing at all, a validation event will not be triggered and the traveler 210 may be marked as “fraudulent.”

As may be understood from at least the foregoing, the barrierless gate 112 may utilize or incorporate video analytics in combination with the functionality offered or implemented by the smart card validators 114a-b, to prevent or mitigate potential fare evasion. Accordingly, it is contemplated that such steps may be taken only when the traveler 210 is marked “invalid ticket” or “fraudulent.” For example, and as discussed in further detail below, when a fraudulent activity or invalid ticket has been identified by analytics software of the camera device 208, the analytics software may perform or implement one or more of the following steps: a) link an image and/or video sequence to the traveler 210; b) remove any unwanted background from the image and/or video sequence to protect the privacy of others, and reduce file size; c) use a face recognition software or algorithm to generate “classifier” data that may be linked to the traveler 210 to enable ease in positively identifying the traveler; d) compress the image and/or video sequence to reduce file size; e) create an event record with the compressed image data; f) append the classifier data to the event record; g) encrypt the event record; h) append to the event record unencrypted date, time, location and event type (e.g., “fare evasion”) data to support record searching; and/or i) securely deliver the event record to a server device(s) 214.

It is contemplated that the event record may remain encrypted in storage, and that the server device 214 may allow only authorized personnel to access records and decrypt data associated with potentially fraudulent entries and exits. Further, it is contemplated that the storage of data records associated with potential fare evasion may trigger a software event to send details of the fare evasion occurrence to one or more fare enforcement entities such as listed police offices, transportation operations staff and the station where the event occurred. For example, referring still to FIG. 2, an enforcement officer 216 may have a mobile device 218 that enables secure mobile access to unencrypt an image and/or video sequence, and associated data when available, for immediate use to enable the enforcement officer 216 to identify any individuals (e.g., the traveler 210) that are non-validated or otherwise unauthorized to access the restricted access area 108. The enforcement officer 216 may be able to add via the mobile device 218 data to the data records presented by the mobile device 218 as the enforcement officer 216 learns more about the incident or the traveler 210 for example. It is contemplated that above-mentioned face recognition classifier(s) may allow events associated with a repeat offender to be pooled together and have any details of the repeat offender shared across multiple event records. Further, the enforcement officer 216 may receive encrypted images and/or video along with the name of an offender when known to the system. The data may be delivered to the mobile device 218 within seconds of an offense so that image and/or video sequence of the offense and/or offender may be displayed by the mobile device 218. When the enforcement officer 216 confronts the traveler 210 for example and wishes to challenge the traveler 210 about a potential fare evasion offense, the enforcement officer 216 may download additional data from the server device 214 including a video snippet. The video snippet may be played back to give the traveler 210 an opportunity to explain their failure to validate.

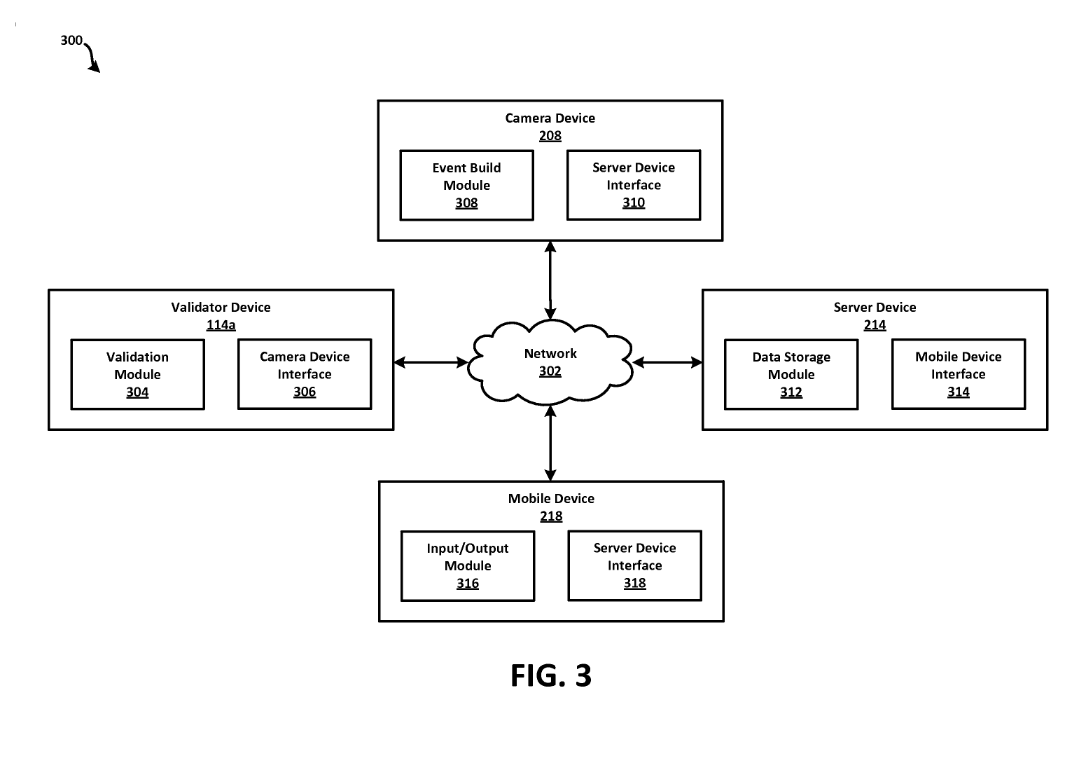

Referring now to FIG. 3, an example networked computing environment 300 is shown in which aspects of the present disclosure may be implemented. In this example, the environment 300 includes multiple components or elements of FIG. 2, including at least one smart card validator 114a, at least one camera device 208, at least one server device 214, and at least one mobile device 218. The environment 300 may further include a network 302. In general, the network 302 is a bi-directional data communication path for data transfer between the smart card validator 114a, the camera device 208, the server device 214, and the mobile device 218. It is contemplated that the network 302 may incorporate or exhibit any number of features or elements of various wireless and/or hardwired packet-based communication networks such as, for example, a WAN (Wide Area Network) network, a HAN (Home Area Network) network, a LAN (Local Area Network) network, a WLAN (Wireless Local Area Network) network, the Internet, or other any type of communication network(s) configured such that data may be transferred among respective elements of the example environment 300.

Other embodiments of the environment 300 are possible. For example, the environment 300 may generally include more or fewer devices, networks, and other components as desired. Further, numbers and types of such devices, networks, and other components may be implementation-specific. Still further, in some embodiments, functionality associated with any particular device as shown in FIG. 3 may wholly or at least partially be implemented on or by one or more other devices as shown in FIG. 3. For example, in some embodiments, one or more modules, components, or interfaces of the server device 214 may wholly or at least partially be implemented or located by or on the camera device 304. Still other embodiments are possible.

In practice, the camera device 208 may track the traveler 210 as the traveler 210 enters the walkway 206 to gain access to the restricted access area 108 via the barrierless gate 112. For example, the camera device 208 may be configured and arranged to capture an initial image of the traveler 210 shown in FIG. 2 as the traveler 210 enters the walkway 206 at about the distance D1+D2 as measured from the barrierless gate 112. The camera device 208 may further be configured and arranged to capture at least one image or video sequence, that may include at least one image, of the traveler 210 at about the distance D1 so that the camera device 208 may capture at least one image of the traveler 210 as or when the traveler 210 swipes or taps their smart card to the smart card validator 114a.

The camera device 208 may associate validation data received from the smart card validator 114a with the traveler 210. In general, a validation module 304 of the smart card validator 114a may detect the smart card 212 and, following implementation of a validation algorithm, may send to the camera device 208 via a camera device interface 306 validation data that may include a timestamp so that the camera device 208 may associate at least one image of the traveler 210 to or with the validation data, along with a tag or marker that indicates whether or not the traveler 210 is validated or otherwise authorized to access the restricted access area 108. For example, the validation data may at least include the information “NAME; NON-VALIDATED; 8 Jul. 2013; 11:02 AM” so that an event build module 308 of the camera device 208 may associate the at least one image of the traveler 210 acquired by the camera device 208 at “8 Jul. 2013; 11:02 AM” with the traveler 210. The event build module 308 of the camera device 208 may further tag or mark the at least one image of the traveler 210 with an indicator “invalid ticket” when the traveler 210 is not authorized (e.g., “NON-VALIDATED”) to access the restricted access area 108.

In general, the camera device 208 may make a determination as to whether or not to save or maintain any images and/or video acquired of the traveler 210. For example, when the traveler 210 is determined to be authorized or approved to enter the restricted access area 108 (e.g., “VALIDATED”), the camera device 208 may generally discard any images and/or video acquired of the traveler 210. However, when the traveler 210 is determined to be unauthorized or unapproved to enter the restricted access area 108 (e.g., “NON-VALIDATED”), the event build module 308 of the camera device 208 may create an event record that includes at least one image of the traveler 210 so that fraudulent or invalid activity may be documented for further action.

For example, the event build module 308 of the camera device 208 may select particular image data of the traveler 210 when the traveler 210 is marked other than “of no interest,” that is, either marked as wither “invalid ticket” or “fraudulent.” In general, the selected image data may be one or both of a still-frame image or a video sequence that contains or includes at least one image. A still-frame image may include an image captured of the traveler 210 by the camera device 208 as the traveler 210 enters the walkway 206 to gain access to the restricted access area 108. A video sequence may include a video segment of predetermined and configurable length (e.g., 2 seconds, 7 seconds, etc.) of the traveler 210 captured by the camera device 208 that includes a missed validation as it is detected in “real-time” that identifies the traveler 210 when the traveler 210 fails to validate. For example, the camera device 208 may be trained on the traveler 210 as the traveler 210 taps the smart card 212 to the smart card validator 114a, or the traveler 210 may fraudulently proceed through the barrierless gate 112 without even attempting to validate. It may be determined relatively quickly whether or not the traveler 210 is properly validated to enter the restricted access area 108. Here, the camera device interface 306 of the smart card validator 114a may communicate a failed validation to the camera device 208 which may then immediately capture a video segment, or continue a video segment capture, of the traveler 210 when the traveler 210 proceeds down the walkway 206 to enter the restricted access area 108 despite a failed or un-attempted validation.

The event build module 308 may further filter selected image data to remove any unwanted or non-relevant information from the selected image data. For example, an image of one or more travelers other than the traveler 210 within the walkway 206 may be included within the selected image data, and that information may be removed, filtered, or deleted from the selected image data to protect the privacy of those other travelers. The event build module 308 may further perform a face recognition algorithm to generate certain classifier data, and may build and encrypt a file, that may be referred to as an event record, that includes one or both of the selected image data and the generated classifier data. Many other types of data may be included within the event record as well such as, for example, the information “NAME; NON-VALIDATED; 8 Jul. 2013; 11:02 AM.”

The event build module 308 may further append support data to the encrypted file to form another, more complete or detailed file that may be referred to as an event package. Although not so limited, an example of support data may include at least one of date, time, location, or event type (e.g., “fare evasion”) to support record searching. Subsequently, a server device interface 310 of the camera device 208 may transfer the event package to the server device 214 so that the event package may be securely stored in a persistent non-transitory storage medium by a data storage module 312 of the server device 214. In general, the event package may be used to address, handle, or otherwise mitigate a potential fare evasion situation.

For example, and as mentioned, the server device interface 310 of the camera device 208 may send an event package to the server device 214, when the traveler 210 is determined unauthorized to access the restricted access area 108. The data storage module 312 of the server device 214 may store the event package in a non-transitory storage medium that is incorporated within or at the server device 214, or in some implementations delocalized from the server device 214. The storage medium may be formatted or structured as any type of relational database so that the data storage module 312 may interact with the storage medium to operate on data as desired. In general, the server device interface 310 may further be communicatively coupled and configured to interact with the mobile device 218.

For example, a mobile device interface 314 of the server device 214 may be configured to send a fare evasion message to the mobile device 218 so that a fare enforcement entity, such as the enforcement officer 216, may investigate a potential fare evasion by the traveler 210. For example, the enforcement officer 216 may receive and access via an input/output module 316 of the mobile device 218 a fare evasion message that includes at least one image of the traveler 210, that includes or shows at least a portion of the face of the traveler 210, and various support data when available to enable the enforcement officer 216 to identify the traveler 210 within the restricted access area 108 if needed. In this example, the enforcement officer 216 may choose to confront and challenge the traveler 210 about a potential fare evasion. However, the enforcement officer 216 may determine that additional information is needed.

For example, a server device interface 318 of the mobile device 218 may be configured to send to the server device 214 a request for an event package associated with the traveler 210 to be sent to the mobile device 218. The data storage module 312 of the server device 214 may in response to the request query a storage medium to retrieve the encrypted event package, and the mobile device interface 314 of the server device 214 may send the encrypted event package to the mobile device 218. In general, the input/output module 316 of the mobile device 218 device may be configured to present content of the both of the fare evasion message and event package to the enforcement officer 216.

For example, the input/output module 316 may display an image of the traveler 210 possibly along with supporting data such as at least one of date, time, location, or event type to enable the enforcement officer 216 to identify the traveler 210 within the restricted access area 108. The input/output module 316 of the mobile device 218 may further display a video sequence of the traveler 210 possibly along with supporting data such as at least one of date, time, location, or event type to enable the enforcement officer 216 to identify the traveler 210 within the restricted access area 108. Other information within the event package and presented via the output display may include validation data, such as for example the information “NAME; NON-VALIDATED; 8 Jul. 2013; 11:02 AM.” Still other information within the event package and presented via the output display may include a detailed history of validation-related incidents involving the traveler 210.

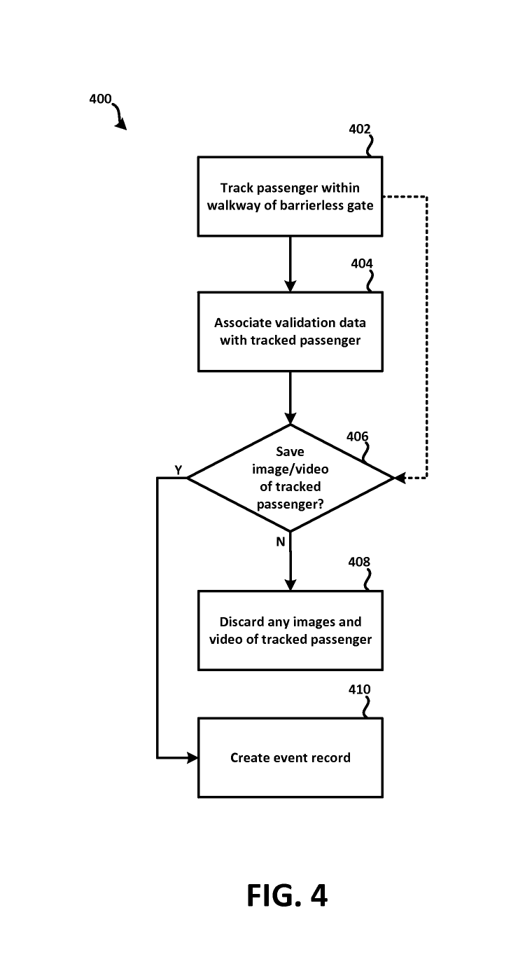

Referring now to FIG. 4, a first example method 400 is shown in accordance with the principles of the present disclosure. In general, the method 400 as described may be performed on or by at least one computing system or device in a networked computing environment. An example of such a computing system or device may include the camera device 208 discussed in connection with at least FIG. 2, and an example of such a networked computing environment may include the environment 300 discussed in connection with at least FIG. 3. Other embodiments are possible.

At step 402, the camera device 208 may track the traveler 210 as the traveler 210 enters the walkway 206 to gain access to the restricted access area 108 via the barrierless gate 112. For example, the camera device 208 may be configured and arranged to capture an initial image of the traveler 210 shown in FIG. 2 as the traveler 210 enters the walkway 206 at about the distance D1+D2 as measured from the barrierless gate 112. The camera device 208 may further be configured and arranged to capture at least one image or video sequence, that may include at least one image, of the traveler 210 at about the distance D1 so that the camera device 208 may capture at least one image of the traveler 210 as or when the traveler 210 swipes or taps their smart card to the smart card validator 114a. This may be beneficial for example if for some reason there is a dispute as to whether the traveler 210 either intentionally or unintentionally did not swipe or tap their smart card to one of the smart card validators 114a-b.

At step 404, the camera device 208 may associate validation data received from one of the smart card validators 114a-b with the traveler 210. In general, the validation data may include a timestamp so that the camera device 208 may associate at least one image of the traveler 210 to or with the validation data, along with a tag or marker that indicates whether or not the traveler 210 is validated or otherwise authorized to access the restricted access area 108. For example, the validation data may at least include the information “NAME; NON-VALIDATED; 8 Jul. 2013; 11:02 AM” so that the camera device 208 may associate the at least one image of the traveler 210 acquired by the camera device 208 at “8 Jul. 2013; 11:02 AM” with the traveler 210. The camera device 208 may further tag or mark the at least one image of the traveler 210 with an indicator “invalid ticket” in the present example where the traveler 210 is not authorized (e.g., “NON-VALIDATED”) to access the restricted access area 108.

In some embodiments, flow within the example method 400 may proceed from step 402 directly to step 406. This is illustrated by intermittent line in FIG. 4. In general, an individual may intentionally or unintentionally bypass the smart card validators 114a-b without being approved, validated, or authorized to enter the restricted access area 108 from the non-restricted access area 110 via the barrierless gate 112. In this and other scenarios the camera device 208 may capture a particular image or video sequence of the traveler 210 that may include or capture at least a portion of a face of the traveler 210 so that the of the traveler 210 may be identifiable by the enforcement officer 216, despite the traveler 210 not interacting with any one of the smart card validators 114a-b.

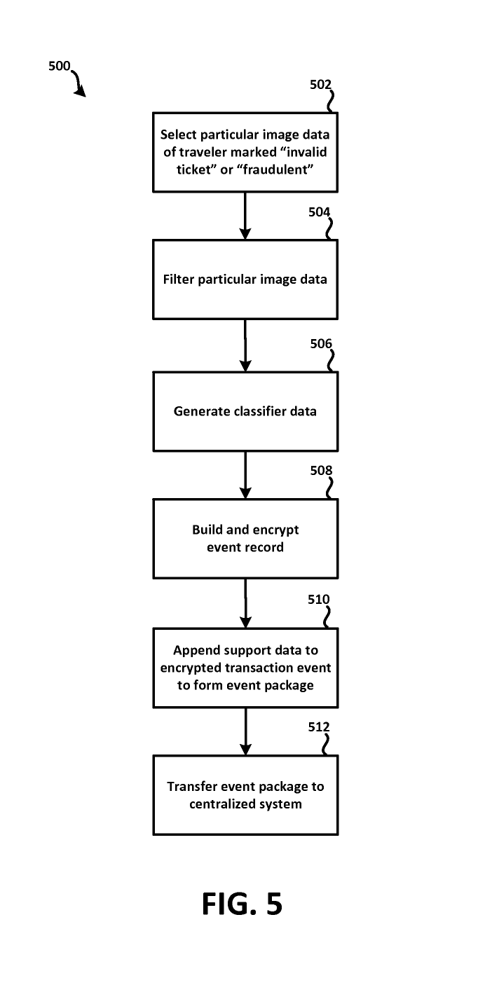

At step 406, the camera device 208 may make a determination as to whether or not to save or maintain any images and/or video acquired of the traveler 210. For example, when the traveler 210 is determined to be authorized or approved to enter the restricted access area 108 (e.g., “VALIDATED”), process flow may branch to step 408 where the camera device 208 may generally discard any images and/or video acquired of the traveler 210. However, when the traveler 210 is determined to be unauthorized or unapproved to enter the restricted access area 108 (e.g., “NON-VALIDATED”), process flow may branch to step 410 where the camera device 208 may create an event record that includes at least one image of the traveler 210 so that fraudulent or invalid activity may be documented for further action. An example of such an implementation is discussed in further detail below in connection with at least FIG. 5.

Referring now to FIG. 5, a second example method 500 is shown in accordance with the principles of the present disclosure. In general, the method 500 as described may be performed on or by at least one computing system or device in a networked computing environment. An example of such a computing system or device may include the camera device 208 discussed in connection with at least FIG. 2, and an example of such a networked computing environment may include the environment 300 discussed in connection with at least FIG. 3. Other embodiments are possible.

At step 502, the camera device 208 may select particular image data of the traveler 210 shown in FIG. 2 when the traveler 210 is marked other than “of no interest,” in a manner as discussed above. In general, the selected image data may be one or both of a still-frame image or a video sequence that contains or includes at least one image. A still-frame image may include an image captured of the traveler 210 by the camera device 208 as the traveler 210 enters the walkway 206 to gain access to the restricted access area 108. A video sequence may include a video segment of predetermined length (e.g., 3 seconds, 5 seconds, etc.) of the traveler 210 captured by the camera device 208 that includes a missed validation as it is detected in “real-time” that identifies the traveler 210 when the traveler 210 fails to validate. For example, the camera device 208 may be trained on the traveler 210 as the traveler 210 taps their smart card to one of the smart card validators 114a-b, or the traveler 210 may fraudulently proceed through the barrierless gate 112 without even attempting to validate. It may be determined very quickly whether or not the traveler 210 is properly validated to enter the restricted access area 108. Here, one of the smart card validators 114a-b may communicate a failed validation to the camera device 208 which may then immediately capture a video segment, or continue a video segment capture, of the traveler 210 when the traveler 210 proceeds down the walkway 206 to enter the restricted access area 108 despite a failed or un-attempted validation.

At step 504, the camera device 208 may filter selected image data to remove any unwanted or non-relevant information from the selected image data. For example, an image of one or more travelers other than the traveler 210 within the walkway 206 may be included within the selected image data, and that information may be removed, filtered, or deleted from the selected image data to protect the privacy of those other travelers. It is further contemplated that the particular selected image data may be modified in other ways as well so as to ensure only relevant information is contained within the selected image data.

At step 506, the camera device 208 may perform a face recognition algorithm to generate certain classifier data. In general, the classifier data may subsequently be used to determine the identity of the traveler 210 for any number of different reasons or purposes. For example, detailed records may be maintained that contain a history of incidents involving the traveler 210 when the traveler 210 is positively identified using the face recognition classifier data. At step 508, the camera device 208 may build and encrypt a file, that may be referred to as an event record, that includes one or both of the selected image data (see step 504) and the generated classifier data (see step 506). In some embodiments, the event record may additionally include associated validation data, such as for example the information “NAME; NON-VALIDATED; 8 Jul. 2013; 11:02 AM.”

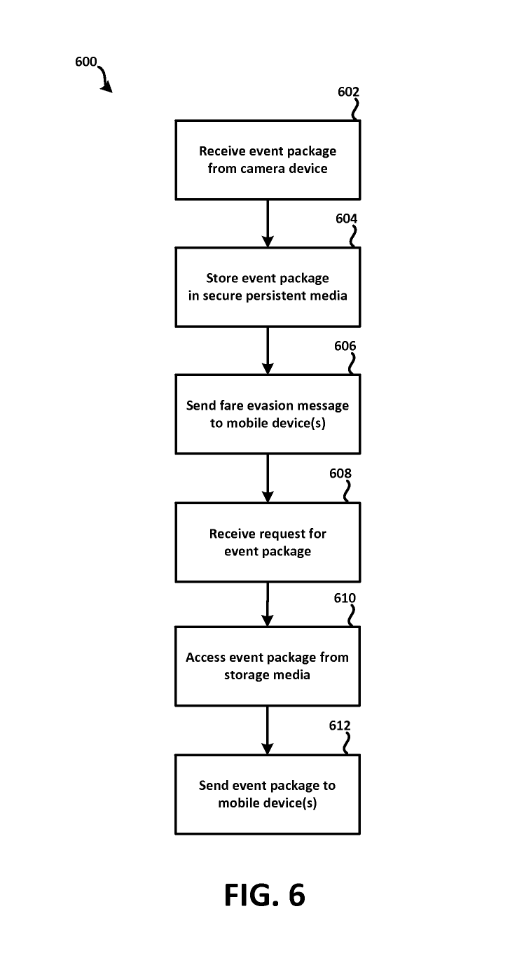

At step 510, the camera device 208 may append support data to the encrypted file to form another, more complete or detailed file that may be referred to as an event package. An example of support data may include at least one of date, time, location, or event type (e.g., “fare evasion”) to support record searching. At step 512, the camera device 208 may transfer the event package to the server device 214 so that the event package may be securely stored in a persistent non-transitory storage medium. In general, the event package may be used to address, handle, or otherwise mitigate a potential fare evasion situation. An example of such an implementation is discussed in further detail below in connection with at least FIG. 6.

Referring now to FIG. 6, a third example method 600 is shown in accordance with the principles of the present disclosure. In general, the method 600 as described may be performed on or by at least one computing system or device in a networked computing environment. An example of such a computing system or device may include the server device 214 discussed in connection with at least FIG. 2, and an example of such a networked computing environment may include the environment 300 discussed in connection with at least FIG. 3. Other embodiments are possible.

At step 602, the server device 214 may receive from the camera device 208 an event package associated with the traveler 210 shown in FIG. 2, when the traveler 210 is determined unauthorized to access the restricted access area 108. In general, the server device 214 may be communicatively coupled to the camera device 208, and any appropriate protocol may be used or leveraged so that the event package may be securely transferred from the camera device 208 to the server device 214. At step 604, the server device 214 may store the event package in a persistent, non-transitory storage medium. Such a storage medium may be incorporated within or at the server device 214, and/or may be delocalized from the server device 214, and thus may be implementation-specific. In general, the storage medium may be formatted or structured as any type of relational database so that the server device 214 may interact with the storage medium to operate on data as desired (e.g., CRUDQ operations).

At step 606, the server device 214 may send a fare evasion message to one or more mobile devices so that a fare enforcement entity may investigate a potential fare evasion by the traveler 210, since in the example description the traveler 210 may generally be marked “invalid ticket” or “fraudulent.” For example, the enforcement officer 216 may receive and access via the mobile device 218 a fare evasion message that includes at least one image of the traveler 210, that includes or shows at least a portion of the face of the traveler 210, and various support data when available to enable the enforcement officer 216 to identify the traveler 210 within the restricted access area 108. In this example, the enforcement officer 216 may choose to confront and challenge the traveler 210 about the potential fare evasion. However, the enforcement officer 216 may determine that additional information is needed.

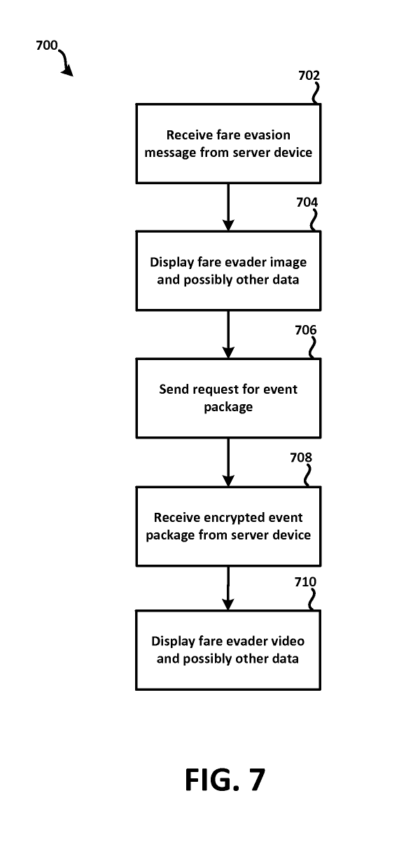

For example, at step 608, the server device 214 may receive a request from the mobile device 218 for an event package associated with the traveler 210 to be sent to the mobile device 218. At step 610, the server device 214 may in response to the request query a storage medium to retrieve the encrypted event package. At step 612, the server device 306 may send the encrypted event package to the mobile device 218. In general, the mobile device 218 device may be configured to present content of the above-mentioned fare evasion message and event package to the enforcement officer 216. An example of such an implementation is discussed in further detail below in connection with at least FIG. 7.

Referring now to FIG. 7, a fourth example method 700 is shown in accordance with the principles of the present disclosure. In general, the method 700 as described may be performed on or by at least one computing system or device in a networked computing environment. An example of such a computing system or device may include the mobile device 218 discussed in connection with at least FIG. 2, and an example of such a networked computing environment may include the environment 300 discussed in connection with at least FIG. 3. Other embodiments are possible.

At step 702, the mobile device 218 shown in FIG. 2 may receive a fare evasion message from the server device 214. At step 704, the mobile device 218 may display via an output display an image of the traveler 210 possibly along with supporting data such as at least one of date, time, location, or event type to enable the enforcement officer 216 to identify the traveler 210 within the restricted access area 108. The enforcement officer 216 may determine that additional information is needed or at least desired. At step 706, the mobile device 218 may send to the server device 214 a request for an event package associated with the traveler 210, and at step 708 the mobile device 218 may receive the event package from the server device 214. At step 710, the mobile device 218 may display via the output display a video sequence of the traveler 210 possibly along with supporting data such as at least one of date, time, location, or event type to enable the enforcement officer 216 to identify the traveler 210 within the restricted access area 108. Other information within the event package and presented via the output display may include validation data, such as for example the information “NAME; NON-VALIDATED; 8 Jul. 2013; 11:02 AM.” Still other information within the event package and presented via the output display may include a detailed history of validation-related incidents involving the traveler 210. Other embodiments are possible.

It is contemplated that one or more features of the example gate array 100 of FIG. 1 may be configured to handle one or more exceptions. For example, one or both of the smart card validators 114a-b may be configured to “beep” in a recognizable way and show a recognizable code on their display screens when a passenger uses a ticket that should only be used by them, e.g. senior citizen's tickets, child tickets, season tickets. Additionally, one or both of the smart card validators 114a-b may be configured to raise an instruction message to the video analytics of the camera device 208 requesting that the camera device 208 generate a “check” request. The instruction may include a timestamp and unique address of the associated one of the smart card validators 114a-b that would allow the camera device 208 to determine which passenger to investigate. Additionally, following a similar process to that performed for failed validations, details of an event and a picture of a passenger may be passed to an on-station revenue inspector. The details of the event may include the relevant details of the ticket (e.g., Senior, Child, Student, Season, etc.). When the inspector is not satisfied after viewing the image, the inspector may pursue the passenger and challenge them.

Further, it is contemplated that other types or forms validation and/or revenue collection may be used an/or are applicable within the context of the present disclosure. For example, a particular smart card may be encoded as a “stored ride” card, where a single stored ride may be deducted from the smart card after each validated entry to the restricted access area 108. Still many other embodiments are possible as well, and it is contemplated that the barrierless gate 112 may incorporate or utilize any type of validation and/or revenue collection mechanism as desired, and further such a mechanism may evolve as validation and/or revenue collection systems evolve.

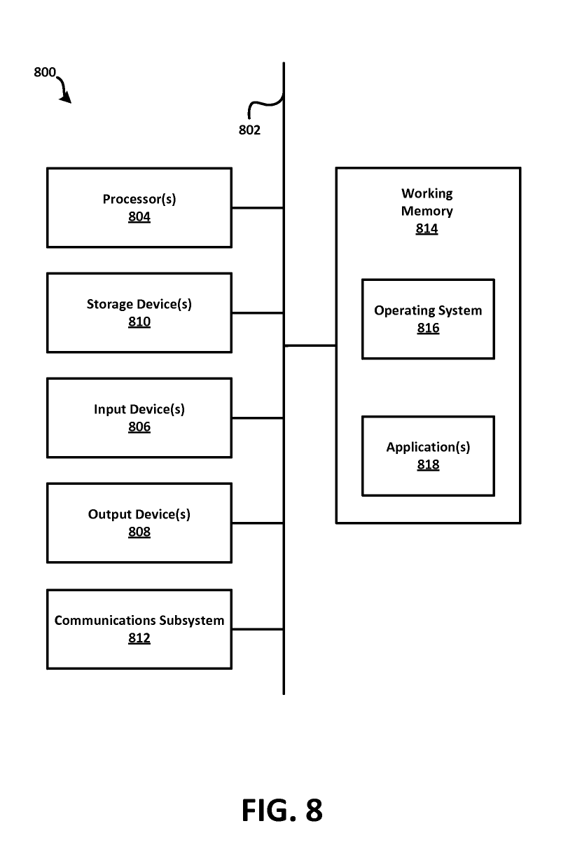

FIG. 8 shows an example computer system or device 800 in accordance with the present disclosure. An example of a computer system or device includes an enterprise server, blade server, desktop computer, laptop computer, tablet computer, personal data assistant, smartphone, a dedicated image or video acquisition system, and/or any other type of computing system or device. The computer system 800 may be wholly or at least partially incorporated as part of previously-described computing devices, such as the smart card validators 114a-b, camera device 208, server device 214, and/or mobile device 218, as described above. Further, the computer device 800 may be configured to perform and/or include instructions that, when executed, cause the computer system 800 to perform the method of at least one of FIGS. 4-7.

The computer device 800 is shown comprising hardware elements that may be electrically coupled via a bus 802 (or may otherwise be in communication, as appropriate). The hardware elements may include a processing unit with one or more processors 804, including without limitation one or more general-purpose processors and/or one or more special-purpose processors (such as digital signal processing chips, graphics acceleration processors, and/or the like); one or more input devices 806, which can include without limitation a remote control, a mouse, a keyboard, and/or the like; and one or more output devices 808, which can include without limitation a presentation device (e.g., television), a printer, and/or the like.

The computer system 800 may further include (and/or be in communication with) one or more non-transitory storage devices 810, which can comprise, without limitation, local and/or network accessible storage, and/or can include, without limitation, a disk drive, a drive array, an optical storage device, a solid-state storage device, such as a random access memory, and/or a read-only memory, which can be programmable, flash-updateable, and/or the like. Such storage devices may be configured to implement any appropriate data stores, including without limitation, various file systems, database structures, and/or the like.

The computer device 800 might also include a communications subsystem 812, which can include without limitation a modem, a network card (wireless or wired), an infrared communication device, a wireless communication device, and/or a chipset (such as a Bluetooth™ device, an 802.11 device, a WiFi device, a WiMax device, cellular communication facilities (e.g., GSM, WCDMA, LTE, etc.), and/or the like. The communications subsystem 812 may permit data to be exchanged with a network (such as the network described below, to name one example), other computer systems, and/or any other devices described herein. In many embodiments, the computer system 800 will further comprise a working memory 814, which may include a random access memory and/or a read-only memory device, as described above.

The computer device 800 also can comprise software elements, shown as being currently located within the working memory 814, including an operating system 816, device drivers, executable libraries, and/or other code, such as one or more application programs 818, which may comprise computer programs provided by various embodiments, and/or may be designed to implement methods, and/or configure systems, provided by other embodiments, as described herein. By way of example, one or more procedures described with respect to the method(s) discussed above, and/or system components might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 810 described above. In some cases, the storage medium might be incorporated within a computer system, such as computer system 800. In other embodiments, the storage medium might be separate from a computer system (e.g., a removable medium, such as flash memory), and/or provided in an installation package, such that the storage medium can be used to program, configure, and/or adapt a general purpose computer with the instructions/code stored thereon. These instructions might take the form of executable code, which is executable by the computer device 800 and/or might take the form of source and/or installable code, which, upon compilation and/or installation on the computer system 800 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer device 800) to perform methods in accordance with various embodiments of the invention. According to a set of embodiments, some or all of the procedures of such methods are performed by the computer system 800 in response to processor 804 executing one or more sequences of one or more instructions (which might be incorporated into the operating system 816 and/or other code, such as an application program 818) contained in the working memory 814. Such instructions may be read into the working memory 814 from another computer-readable medium, such as one or more of the storage device(s) 810. Merely by way of example, execution of the sequences of instructions contained in the working memory 814 may cause the processor(s) 804 to perform one or more procedures of the methods described herein.

The terms machine-readable medium (media) and computer-readable medium (media), as used herein, may refer to any medium that participates in providing data that causes a machine to operate in a specific fashion. In an embodiment implemented using the computer device 800, various computer-readable media might be involved in providing instructions/code to processor(s) 804 for execution and/or might be used to store and/or carry such instructions/code. In many implementations, a computer-readable medium is a physical and/or tangible storage medium. Such a medium may take the form of a non-volatile media or volatile media. Non-volatile media may include, for example, optical and/or magnetic disks, such as the storage device(s) 810. Volatile media may include, without limitation, dynamic memory, such as the working memory 814.

Example forms of physical and/or tangible computer-readable media may include a floppy disk, a flexible disk, hard disk, magnetic tape, or any other magnetic medium, a CD-ROM, any other optical medium, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 804 for execution. By way of example, the instructions may initially be carried on a magnetic disk and/or optical disc of a remote computer. A remote computer might load the instructions into its dynamic memory and send the instructions as signals over a transmission medium to be received and/or executed by the computer system 800.

The communications subsystem 812 (and/or components thereof) generally will receive signals, and the bus 802 then might carry the signals (and/or the data, instructions, etc. carried by the signals) to the working memory 814, from which the processor(s) 804 retrieves and executes the instructions. The instructions received by the working memory 814 may optionally be stored on a non-transitory storage device 810 either before or after execution by the processor(s) 804.

The methods, systems, and devices discussed above are examples. Various configurations may omit, substitute, or add various method steps or procedures, or system components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Furthermore, the example embodiments described herein may be implemented as logical operations in a computing device in a networked computing system environment. The logical operations may be implemented as: (i) a sequence of computer implemented instructions, steps, or program modules running on a computing device; and (ii) interconnected logic or hardware modules running within a computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system, comprising:
a barrierless gate that defines a passageway and that separates a non-restricted access area from a restricted access area;
at least one credential validator positioned at a particular distance from the barrierless gate within the non-restricted access area along a walkway leading to the barrierless gate; and
at least one image capture device that is coupled to the barrierless gate and that is configured to acquire at least one image of each individual that approaches the at least one credential validator along the walkway to enter the restricted access area though the barrierless gate, and associate based on information received from the at least one credential validator at least one particular image with each individual determined unauthorized to enter the restricted access area.

2. The system of claim 1, wherein the at least one image capture device is further configured to acquire and associate a particular video sequence with each unauthorized individual based on information received from the at least one credential validator.

3. The system of claim 1, wherein the at least one image capture device is further configured to acquire and associate a particular image or video sequence with each individual that approaches the at least one credential validator along the walkway to enter the restricted access area though the barrierless gate based on absence of information received from the at least one credential validator about any particular individual.

4. The system of claim 1, wherein the at least one image capture device is further configured to:
track each individual that approaches the at least one credential validator along the walkway to enter the restricted access area though the barrierless gate;
link particular validation data, selected from one of data indicating confirmed validation or unconfirmed validation, received from the at least one credential validator with each tracked individual; and
associate a particular image or video segment with each tracked individual having unconfirmed validation to enable the fare enforcement entity to identify individuals having unconfirmed validation.

5. The system of claim 1, wherein the at least one image capture device comprises an integrated camera and computing system communicatively coupled to the at least one credential validator, and is further configured to capture at least one image of each individual at a predefined distance from the barrierless gate within the non-restricted access area, and a video sequence of predetermined length of each individual within non-restricted access area that approaches the at least one credential validator along the walkway to enter the restricted access area though the barrierless gate.

6. The system of claim 1, further comprising a computing system communicatively coupled to the at least one image capture device and separate from the at least one credential validator and the at least one image capture device, wherein the at least one image capture device is further configured to generate and send to the computing system an event record for each individual unauthorized to enter the restricted access area, wherein each particular event record includes at least one image of an associated individual.

7. The system of claim 1, further comprising at least one mobile computing device communicatively coupled to one of the at least one image capture device or a computing system separate from the at least one image capture device, wherein the at least one mobile computing device is configured to receive from one of the at least one image capture device or the computing system a particular image or video sequence of each individual unauthorized to enter the restricted access area to enable the fare enforcement entity to identify individuals unauthorized to enter the restricted access area.

8. The system of claim 1, further comprising a first partition and a second partition each extending from the barrierless gate within the non-restricted access area to define the walkway leading to the barrierless gate so that a corridor that leads from the non-restricted access area to the restricted access area is defined by the first and second partition and the barrierless gate, and wherein the at least one credential validator is coupled to one of the first partition or the second partition.

9. The system of claim 1, wherein the barrierless gate comprises an arched structure so that to enter the restricted access area from the non-restricted access area each individual passes through the arched structure unimpeded by a barrier.

10. The system of claim 1, wherein the at least one credential validator is at least one of a contact or contactless card reader configured to detect smart cards to validate fare collection and authorize access to the restricted access area.

11. A computer-implemented method, comprising:
tracking a particular individual that approaches a barrierless gate that separates a non-restricted access area from a restricted access area;
determining, based on information received from a smart card reader positioned at a particular distance from the barrierless gate within the non-restricted access area, whether the particular individual is authorized to access the restricted access area; and
when the particular individual is determined unauthorized to access the restricted access area, capturing at least one of an image of the particular individual to enable a fare enforcement entity to identify and confront the particular individual about potential unauthorized access to the restricted access area.

12. The method of claim 11, further comprising filtering the image to remove information unrelated to the particular individual.

13. The method of claim 11, further comprising performing a facial recognition algorithm against the image to generate at least one classifier that characterizes at least one facial feature of the particular individual.

14. The method of claim 11, further comprising performing a data compression algorithm against the image to encode the image or video sequence prior to transfer of the image or video sequence to secure data storage.

15. The method of claim 11, further comprising: appending classifier data that characterizes at least one facial feature of the particular individual to the image or video sequence; encrypting the classifier data and the image to form an event package; and transmitting the event package to a non-transitory storage medium for storage therein.

16. The method of claim 11, further comprising sending the image or video sequence to at least one mobile device for display thereon to enable a fare enforcement entity to identify and confront the particular individual about potential unauthorized access to the restricted access area.

17. The method of claim 11, further comprising: appending classifier data that specifies at least one of date, time, location, or event type to the image or video sequence to form an event package; and transmitting the event package to a non-transitory storage medium for storage therein.

18. The method of claim 11, further comprising:
determining, based on absence of information received from the smart card reader, that the particular individual is unauthorized to access the restricted access area; and
in response to determining that the particular individual is unauthorized to access the restricted access area, capturing at least one of an image of the particular individual, and sending the at least one of an image to at least one mobile device to enable the fare enforcement entity to identify and confront the particular individual about potential unauthorized access to the restricted access area.

19. An integrated camera and computing system positioned to a barrierless gate that defines a passageway and that separates a non-restricted access area from a restricted access area, comprising:
one or more processors; and
a memory communicatively coupled with and readable by the one or more processors and having stored therein processor-readable instructions which, when executed by the one or more processors, cause the one or more processors to:
track a particular individual that approaches the barrierless gate that separates the non-restricted access area from the restricted access area;
determine, based on information received from a smart card validator positioned at a particular distance from the barrierless gate within the non-restricted access area, whether the particular individual is authorized to access the restricted access area; and
when the particular individual is determined unauthorized to access the restricted access area, capture at least one of an image or video sequence of the particular individual to enable a fare enforcement entity to identify and confront the particular individual about potential unauthorized access to the restricted access area.

20. The computing system of claim 19, wherein the memory having stored therein processor-readable instructions which, when executed by the one or more processors, further cause the one or more processors to at least one of:
filter the image or video sequence to remove information unrelated to the particular individual;
perform a facial recognition algorithm against the image or video sequence to generate at least one classifier that characterizes at least one facial feature of the particular individual;
perform a data compression algorithm against the image or video sequence to encode the image or video sequence prior to transfer of the image or video sequence to secure data storage;
append classifier data that characterizes at least one facial feature of the particular individual to the image or video sequence; encrypting the classifier data and the image or video sequence to form an event package; and transmitting the event package to a non-transitory storage medium for storage therein;
send the image or video sequence to at least one mobile device for display thereon to enable a fare enforcement entity to identify and confront the particular individual about potential unauthorized access to the restricted access area; or
determine, based on absence of information received from the smart card reader, that the particular individual is unauthorized to access the restricted access area, capture at least one of an image or video sequence of the particular individual, and send the at least one of an image or video sequence to at least one mobile device to enable the fare enforcement entity to identify and confront the particular individual about potential unauthorized access to the restricted access area.
